(19) United States
(12) Patent Application Publication
(10) Pub. No.: US 2013/0256429 A1
(43) Pub. Date: Oct. 3, 2013

(54) FUEL INJECTION VALVE

(71) Applicant: Tatsuo Kobayashi, Susono-shi (JP)

(72) Inventor: Tatsuo Kobayashi, Susono-shi (JP)

(73) Assignee: TOYOTA JIDOSHA KABUSHIKI KAISHA, Toyota-shi, Aichi-ken (JP)

(21) Appl. No.: 13/991,563

(22) PCT Filed: Dec. 20, 2010
(86) PCT No.: PCT/JP2010/072939

§ 371 Date: Jun. 4, 2013

(51) Int. Cl. F02M 61/16

(52) U.S. Cl. CPC F02M 61/163
USPC 239/488

(57) ABSTRACT

A fuel injection valve includes: a nozzle body; a needle that is slidably arranged in the nozzle body and sits on a seat portion in the nozzle body, the needle and the nozzle body forming a fuel introduction path therebetween; a spiral fuel path that is formed at an upstream side of the seat portion, and gives a flow which swirls around the needle to a fuel which is introduced from the fuel introduction path and supplied to the injection hole; and an acceleration portion that is formed between the seat portion and the injection hole, accelerates the swirling fuel which has passed through the fuel path, and generates a negative pressure at the center of swirling flow of the fuel to generate an air core; wherein the fuel path is formed to the outside of an outer peripheral surface of the needle.

### TECHNICAL FIELD

The present invention is related to a fuel injection valve.

### BACKGROUND ART

Recently, supercharged lean burn, extensive EGR, and homogeneous charge ignition combustion are briskly researched for CO₂ reduction and emission reduction with respect to an internal combustion engine. According to these researches, in order to pull out the effect of the CO₂ reduction and the emission reduction to the utmost, it is necessary to acquire a stable combustion state in vicinity to a combustion limit. While depletion of an oil fuel progresses, the robustness in which even various fuels, such as a biofuel, can be stably burned is required. The most important point for obtaining such stable combustion is to reduce the ignition fluctuation of a fuel-air mixture, and to require prompt combustion in which a fuel is burned out in an expansion stroke.

Then, in the fuel supply of the internal combustion engine, a cylinder injection system which directly injects the fuel into a combustion chamber is employed for the improvement in transient response, the improvement in volumetric efficiency by latent heat of vaporization, and large retard combustion for catalytic activation in a low temperature. However, by employing the cylinder injection system, combustion fluctuation has been promoted by oil dilution caused by a spray fuel colliding with a combustion chamber wall as a droplet, and the aggravation of spray caused by deposit generated around an injection hole of an injection valve with the use of a liquid fuel.

In order to take measures against the oil dilution and the aggravation of the spray caused by employing such a cylinder injection system, to reduce the ignition fluctuation, and to realize stable combustion, it is important to atomize the spray so that the fuel in the combustion chamber evaporates promptly.

In order to atomize the spray injected from the fuel injection valve, there are known a method for using a shearing force of a thinned liquid film, a method for using cavitation caused by exfoliation of flow, a method for atomizing the fuel adhering to a surface by using mechanical vibration of an ultrasonic wave, and so on. The fuel injection valve atomizing the spray, which is disclosed by Patent Document 1, gives strong swirling flow to the fuel to be injected by a swirling flow generation section on which a spiral groove provided on a needle is formed, decreases a pressure of a central part of the swirling flow, and supplies an air to the central part of the swirling flow. The air is given to the swirling flow of the fuel, so that fine bubbles are generated, and a bubble fuel including the fine bubbles is injected. Then, after the injection, the spray is atomized by using energy in which the fine bubbles burst.

Patent Document 2 suggests an injection valve that gives swirling component to the fuel by a spiral path provided on a valve disk, spreads the spray, disperses the fuel, and promotes mixture with the fuel and the air. Patent Document 3 discloses injecting the fuel mixed with bubbles caused by using a differential pressure between a bubble generation path and a bubble keeping path, and atomizing the fuel by energy in which the bubbles collapse in the fuel after the injection. In addition, Patent Document 4 discloses incorporating a swirl component constituted from a spirally twisted polyhedra into a nozzle body, and obtaining the swirl by guiding the fuel to a spiral path formed with the polyhedra and a wall face of the nozzle body.

### PRIOR ART DOCUMENT

### Patent Document

[Patent Document 1] International Patent Application No. PCT/JP2010/056372
[Patent Document 2] Japanese Patent Application Publication No. 10-141183
[Patent Document 3] Japanese Patent Application Publication No. 2006-177174
[Patent Document 4] Japanese National Publication of International Patent Application No. 2004-518052

### SUMMARY OF THE INVENTION

### Problems to be Solved by the Invention

As described above, the strong swirling flow is given to the fuel to be injected and the air is supplied to the central part of the swirling flow, so that the bubble fuel including the fine bubbles can be formed. With this bubble fuel, when the fine bubbles burst, the spray of the fuel is atomized. By the way, the diameter of the bubbles generated in this way is effective for the atomization of the spray of the fuel as a stronger swirling flow is formed. In order to form the stronger swirling flow, it is necessary to increase the swirling component to be given to the fuel. In order to increase the swirling component, the diameter of the spiral path which gives the swirling component is enlarged. However, the conventional art which gives the swirling component to the fuel has a structure in which the spiral path is provided on the needle valve (see Patent Documents 1 and 2), or a structure in which the spiral path is provided on a member which moves along with the needle valve (see Patent Document 4), so that the weight of the needle valve which is a moving part becomes large. The aggravation of the response of the needle valve at the time of lift, the increase in the power consumption for driving the needle valve, and also increasing size of the injection valve itself have arisen.

It is an object of the present invention to provide a fuel injection valve that atomizes the spray of the fuel by the injection of the fuel including the fine bubbles, realizes stable combustion, and reduces the weight of a needle.

### Means for Solving the Problems

To solve the above problem, a fuel injection valve of the present invention is characterized by comprising: a nozzle body having a frond edge portion at which an injection hole is provided; a needle that is slidably arranged in the nozzle body and sits on a seat portion in the nozzle body, the needle and the nozzle body forming a fuel introduction path therebetween; a spiral fuel path that is formed at an upstream side of the seat portion, and gives a flow which swirls around the needle to a fuel which is introduced from the fuel introduction path and supplied to the injection hole; and an acceleration portion that is formed between the seat portion and the injection hole, and accelerates the swirling fuel which has passed through the fuel path; wherein the fuel path is formed to the outside of an outer peripheral surface of the needle.

The spiral fuel path required to generate sufficient swirling flow for generating fine bubbles can be provided on a different part from the needle. Therefore, the diameter of the needle can be reduced and the needle can be made lightweight, compared with the conventional needle on which the spiral fuel path is provided. As a result, improvement in the response of the needle, restraint in the power consumption concerning operation of the needle, and miniaturization of the fuel injection valve are attained.

The above-mentioned fuel injection valve may includes: a swirling flow generation member arranged between the fuel introduction path and the seat portion in the inside of the nozzle body; wherein the needle slidably penetrates the swirling flow generation member, and the fuel path is formed with a spiral groove provided on an inner circumferential side surface of the nozzle body, and/or a spiral groove provided on an outer circumferential side surface of the swirling flow generation member.

The spiral groove is provided on the swirling flow generation member, so that the fuel path forming the swirling flow is formed. Therefore, the process of the spiral groove becomes easier, the productivity can be improved, and the cost can be reduced.

In the above-mentioned fuel injection valve, the fuel path may be formed in the nozzle body. By forming the fuel path in the nozzle body, the swirling flow for generating the fine bubbles can be formed. Thus, since the fuel path is formed in the nozzle body, the diameter of the needle can be reduced and the needle can be made lightweight.

In the above-mentioned fuel injection valve, a downstream side of the fuel path may be formed along a hemisphere surface. The fuel path is formed along the hemisphere surface, so that a spiral radius of the fuel path can reduce gradually. Thereby, the swirling velocity of the fuel can be amplified efficiently until the fuel reaches the vicinity of the sheet portion. Moreover, the swirling flow can be generated since the needle has been opened.

In the above-mentioned fuel injection valve, a cross-sectional area of the fuel path may be constant. By making the cross-sectional area of the spiral fuel path constant, the contracted flow of the fuel is restrained. Accordingly, the flow resistance becomes small, the fuel pressure is lowered, and the velocity of the swirling flow can be maintained.

The above-mentioned fuel injection valve having the swirling flow generation member may include a moving mechanism that moves only the needle when a lift amount of the needle is small, and moves the needle and the swirling flow generation member when the lift amount of the needle is large. When the needle and the swirling flow generation member are moved, the pressure loss of the fuel by the flow resistance can decrease. Thus, according to the construction, when the lift amount of the needle is small, i.e., when there is little injection quantity of the fuel, the swirling flow can be amplified. When the lift amount of the needle is large, i.e., when there is much injection quantity of the fuel, the pressure loss can decrease and the fuel flow can be secured.

The moving mechanism may include: a jaw portion provided on the needle; a recess portion that is formed on an inner circumferential side surface of the swirling flow generation member, and is configured so that the jaw portion moves slidably; and an elastic member that is provided between a front edge surface of the recess portion and a front edge surface of the jaw portion, and presses the swirling flow generation member to a front edge side of the needle; wherein when the needle lifts and a rear edge surface of the jaw portion contacts a rear edge surface of the recess portion, the swirling flow generation member moves along with the needle. According to the construction, the lift amount of the swirling flow generation member can be determined depending on the lift amount of the needle without performing a particular control. That is, the intensity of the swirling flow and the fuel flow can be adjusted depending on the injection quantity of the fuel.

### Effects of the Invention

According to the fuel injection valve of the present invention, the spiral fuel path which causes the swirling flow generating the fine bubbles is formed to the outside of the side surface of the needle away from the needle axis, so that the fuel path can be provided on a different part from the needle. Thereby, a diameter of the needle can be reduced and the needle can be made lightweight, compared with the conventional needle on which the spiral fuel path is provided. As a result, improvement in the response of the needle, restraint in the power consumption concerning operation of the needle, and miniaturization of the fuel injection valve are attained.

### BRIEF DESCRIPTION OF THE DRAWINGS

FIG. 1 is a diagram illustrating an example of the structure of an engine system equipped with a fuel injection valve;

FIG. 2 is a cross-section diagram illustrating the schematic structure of the fuel injection valve;

FIG. 3 is an enlarged diagram of a front edge portion of the fuel injection valve;

FIG. 4 is an enlarged diagram illustrating the vicinity of an injection hole of the fuel injection valve;

FIG. 5 is a cross-section diagram illustrating the vicinity of a swirling flow generation member of the fuel injection valve according to a second embodiment;

FIG. 6 is an appearance diagram of the swirling flow generation member;

FIG. 7 is a diagram illustrating the fuel injection valve in a state where only a needle is lifted, according to a third embodiment;

FIG. 8 is a diagram illustrating the fuel injection valve in a state where the swirling flow generation member is lifted along with the needle, according to the third embodiment;

FIG. 9 is a diagram illustrating a relationship between a bubble diameter and a fuel pressure;

FIG. 10 is a diagrams of the fuel injection valve in which a spiral groove is provided on an inner circumferential side surface of a nozzle body; and

FIG. 11 is a diagrams of the fuel injection valve in which the spiral groove is provided on an outer circumferential side surface of the swirling flow generation member and the inner circumferential side surface of the nozzle body.

### MODES FOR CARRYING OUT THE INVENTION

Hereinafter, a description will be given of an embodiment of the present invention with reference to the drawings.

### First Embodiment

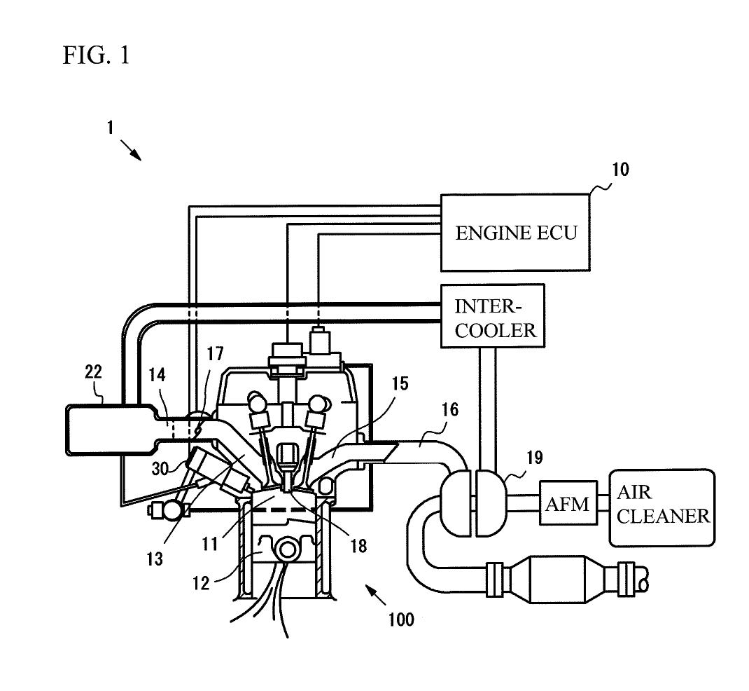

A first embodiment of the present invention is described with reference to the drawings. FIG. 1 is a diagram illustrating an example of the structure of an engine system 1 equipped with a fuel injection valve 30. Here, FIG. 1 illustrates only a part of the structure of an engine 100.

The engine system 1 illustrated in FIG. 1 is equipped with the engine 100 as a power source, and an engine ECU (Electronic Control Unit) 10 that comprehensively controls driving operation of the engine 100. The engine system 1 is equipped with the fuel injection valve 30 that injects a fuel into a combustion chamber 11 of the engine 100. The engine ECU 10 has a function of a controller. The engine ECU 10 is a computer that includes a CPU (Central Processing Unit) performing an arithmetic process, a ROM (Read Only Memory) storing a program, and a RAM (Random Access Memory) and a NVRAM (Non Volatile RAM) storing data.

The engine 100 is an engine to be equipped with a vehicle, and includes a piston 12 which constitutes the combustion chamber 11. The piston 12 is slidably fitted into a cylinder of the engine 100. Then, the piston 12 is coupled with a crankshaft which is an output shaft member, via a connecting rod.

An intake air flowed into the combustion chamber 11 from an intake port 13 is compressed in the combustion chamber 11 by the upward movement of the piston 12. The engine ECU 10 decides fuel injection timing and transmits a signal to the fuel injection valve 30, based on information on a position of the piston 12 from a crank angle sensor and a rotary phase of a camshaft from an intake cam angle sensor. The fuel injection valve 30 injects the fuel at specified injection timing in response to the signal from the engine ECU 10. The fuel injected from the fuel injection valve 30 is atomized to be mixed with the compressed intake air. The fuel mixed with the intake air is ignited with a spark plug 18 to be burned, so that combustion chamber 11 is expanded to move the piston 12 downwardly. The downward movement is changed to the rotation of the crankshaft via the connecting rod, so that the engine 100 obtains power.

The combustion chamber 11 is connected to the intake port 13, and an intake path 14 which is connected to the intake port 13 to introduce the intake air therefrom to the combustion chamber 11. Further, the combustion chamber 11 of each cylinder is connected to an exhaust port 15 and an exhaust path 16 to introduce an exhaust gas generated in the combustion chamber 11 to the outside of the engine 100. A surge tank 22 is arranged at the intake path 14.

An airflow meter, a throttle valve 17 and a throttle position sensor are installed in the intake path 14. The airflow meter and the throttle position sensor respectively detect a volume of the intake air passing through the intake path 14 and an opening degree of the throttle valve 17 to transmit the detection results to the engine ECU 10. The engine ECU 10 recognizes the volume of the intake air introduced to the intake port 13 and the combustion chamber 11 on the basis of the transmitted detection results, and adjusts the opening degree of the throttle valve 17 to adjust the volume of the intake air.

A turbocharger 19 is arranged at the exhaust path 16. The turbocharger 19 uses the kinetic energy of the exhaust gas passing through the exhaust path 16, thereby allowing a turbine to rotate. Therefore, the intake air that has passed through an air cleaner is compressed to flow into an intercooler. After the compressed intake air is cooled in the intercooler to be temporarily retained in the surge tank 22, it is introduced into the intake path 14. In this case, the engine 100 is not limited to a supercharged engine provided with the turbocharger 19, and may be a normally aspirated (Natural Aspiration) engine.

The piston 12 is provided with a cavity at the top surface thereof. As for the cavity, the wall surface is formed by a curved surface which is gently continued from a direction of the fuel injection valve 30 to a direction of the spark plug 18, and the fuel injected from the fuel injection valve 30 is introduced to the vicinity of the spark plug 18 along the shape of the wall surface. In this case, the cavity of the piston 12 can be formed in an arbitrary shape at an arbitrary position in response to the specification of the engine 100. For example, a re-entrant type combustion chamber may be provided in such a manner that a circular cavity is formed at the central portion of the top surface of the piston 12.

The fuel injection valve 30 is mounted in the combustion chamber 11 under the intake port 13. On the basis of an instruction from the ECU 10, the fuel injection valve 30 directly injects the high-pressured fuel supplied from a fuel pump via a fuel path into the combustion chamber 11 through an injection hole 33 provided at a front edge portion of a nozzle body 31. The injected fuel is atomized and mixed with the intake air in the combustion chamber 11 to be introduced to the vicinity of the spark plug 18 along the shape of the cavity. The leak fuel of the fuel injection valve 30 is returned from a relief valve to a fuel tank through a relief pipe.

The fuel injection valve 30 is not limited to the arrangement under the intake port 13. The fuel injection valve 30 may be arranged at an arbitrary position in the combustion chamber 11. For example, the fuel injection valve 30 may be arranged such that the fuel is injected from a top center part of the combustion chamber 11.

Here, the engine 100 may be any one of a gasoline engine using gasoline as the fuel, a diesel engine using a diesel oil as the fuel, and a flexible fuel engine using a fuel containing the gasoline and the diesel oil at an arbitrary ratio. Also, the engine system 1 may be a hybrid system which combines the engine 100 and plural electric motors.

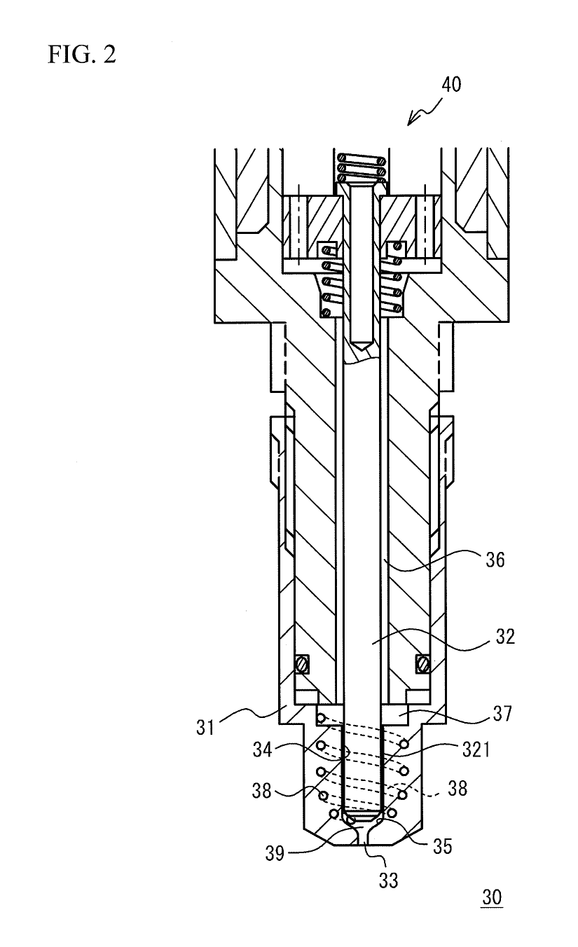

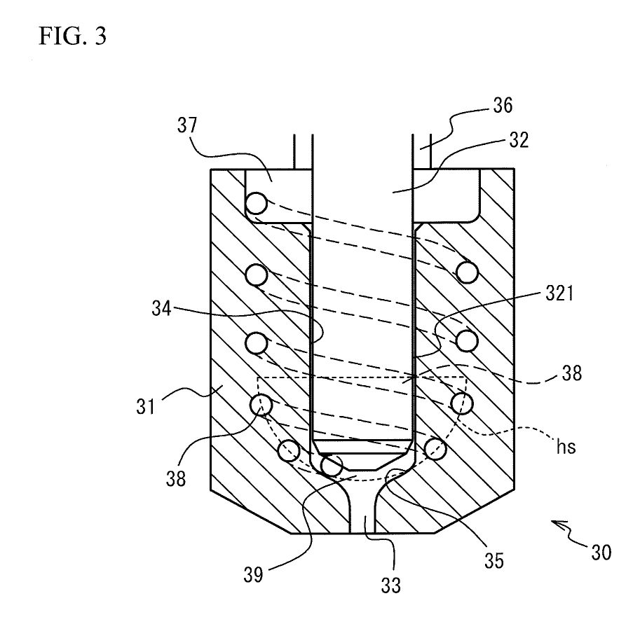

Next, an inner structure of the fuel injection valve 30 in the embodiment according to the invention will be described in detail. FIG. 2 is an explanatory diagram illustrating the schematic structure of a cross-section surface of the fuel injection valve 30. FIG. 3 is an enlarged explanatory diagram of the front edge portion of the fuel injection valve 30 in FIG. 2. The fuel injection valve 30 is provided with the nozzle body 31, a needle 32, and a driving mechanism 40. In the following description, a front edge side indicates a moving direction of the needle 32 when the valve is closed, i.e., a lower side in the drawings. A rear edge side indicates a moving direction of the needle 32 when the valve is opened, i.e., an upper side in the drawings.

The injection hole 33 is provided at the front edge portion of the nozzle body 31. In the front edge portion of the nozzle body 31, the injection hole 33 is formed in a direction along an axis of the nozzle body 31. A needle guide 34 that guides the needle 32 is formed in the inside of the nozzle body 31. In addition, a seat portion 35 is provided between the injection hole 33 of the nozzle body 31 and the needle guide 34. The needle 32 is slidably arranged in the nozzle body 31 and sits on the seat portion 35 in the nozzle body 31. A fuel introduction path 36 is formed between the needle 32 and the nozzle body 31.

An adjustment room 37 for storing the fuel is formed at the front edge side of the fuel introduction path 36. The adjustment room 37 is located at the rear edge side of the needle guide 34. The fuel in the adjustment room 37 is introduced from the fuel introduction path 36.

Moreover, a fuel path 38 is formed in the nozzle body 31 so as to connect the adjustment room 37 to the front edge side of the seat portion 35. The fuel path 38 is formed to the outside of an outer peripheral surface 321 of the needle 32. Specifically, the fuel path 38 is a path formed so that the spiral is drawn around the axis of the needle 32. Further, the fuel path 38 is formed at a position further away from the axis of the needle 32, compared with the outer peripheral surface 321 of the needle 32. That is, the fuel path 38 is not provided on the needle 32 located at the center side of the fuel injection valve 30, and is provided in the nozzle body 31 located at the outer peripheral side of the fuel injection valve 30. In addition, the fuel path 38 is formed at the upstream side (the rear edge side) of the seat portion 35, and gives the flow which swirls around the needle 32 to the fuel which is introduced from the fuel introduction path 36 and supplied to the injection hole 33.

Then, a downstream side of the fuel path 38 is formed along a hemisphere surface hs. The downstream side of the fuel path 38 through which the fuel flows is formed along the hemisphere surface, so that a spiral radius of the fuel path 38 reduces gradually. Thus, since the spiral radius reduces gradually, the flow of the direction in which the fuel swirls is formed efficiently until the fuel passes through an opening in the side of the seat portion 35.

Then, in the inside of the nozzle body 31, an acceleration portion 39 is formed between the seat portion 35 and the injection hole 33. The acceleration portion 39 accelerates the swirling fuel which has passed through the fuel path 38. Since an inside diameter of the nozzle body 31 between the seat portion 35 and the injection hole 33 in which the acceleration portion 39 is located is continuously reduced towards the injection hole 33 from the seat portion 35, the flow path through which the fuel passes is narrowed down. Therefore, the fuel which passes through the acceleration portion 39 is accelerated.

The driving mechanism 40 controls sliding operation of the needle 32. The driving mechanism 40 is conventionally known, and is equipped with parts suitable for the operation of the needle 32, such as an actuator which used a piezoelectric device and an electromagnet, and an elastic component which gives a suitable pressure to the needle 32.

By the way, when the needle 32 sits on the seat portion 35 in the fuel injection valve 30, the injection of the fuel is stopped. When the needle 32 moves to the rear edge side from this state, and separates from the seat portion 35, the adjustment room 37 and the injection hole 33 are connected to each other, and the fuel is injected. At this time, the fuel in the adjustment room 37 passes through the fuel path 38, and is supplied to the acceleration portion 39. Since the fuel to be passed through the fuel path 38 passes through the path formed spirally, the swirling flow is generated along the spiral. Moreover, the flow of the fuel having swirling component is accelerated in the acceleration portion 39 in which the flow path is narrowed down.

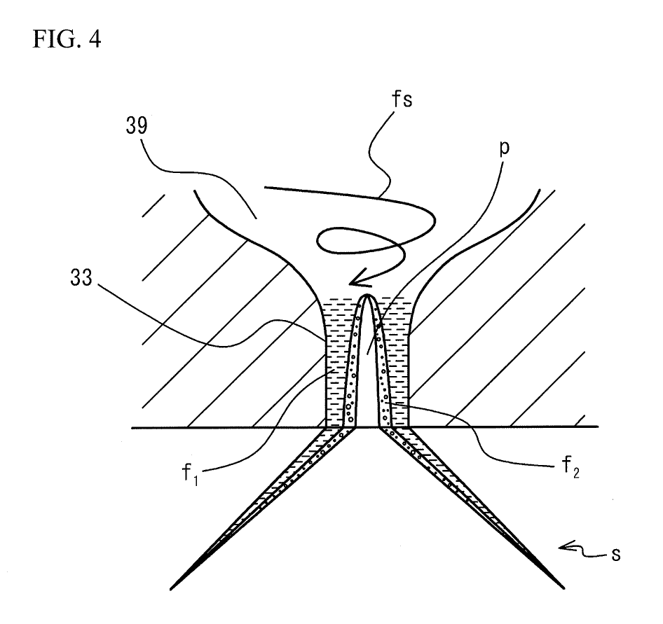

Next, a description will be given of a phenomenon in the acceleration portion 39 with reference to FIG. 4. FIG. 4 is an enlarged diagram illustrating the vicinity of the injection hole 33 of the fuel injection valve 30. When the swirling flow is accelerated in the acceleration portion 39, a strong swirling flow fs is formed in the injection hole 33 and the acceleration portion 39, and a negative pressure occurs at the center in which the strong swirling flow fs swirls. When the negative pressure occurs, the external air around the nozzle body 31 is sucked in the nozzle body 31, and an air core p is generated in the injection hole 33 and the acceleration portion 39. Bubbles are generated from the interface of the air core p generated by such a way. The generated bubbles are mixed into the fuel which flows around the air core, and the generated bubbles are injected as a bubble mixture flow f₂ along with a fuel flow f₁ which flows in the outer circumferential side.

At this time, the bubble mixture flow f₂ and the fuel flow f₁ form a cone-shaped spray s diffused from the center by a centrifugal force of the swirling flow. Therefore, as the spray separates from the injection hole 33, the diameter of the spray s becomes large, so that a spray liquid film is extended and becomes thin, and the spray liquid film cannot be maintained as the liquid film soon and is divided. The diameter of the spray after division becomes small according to a self-pressurization effect of the fine bubbles, the spray results in collapse and turns into an ultrafine spray. Thus, the spray of the fuel injected by the fuel injection valve 30 is atomized, so that prompt flame propagation in the combustion chamber is realized and stable combustion is performed.

As described above, the fuel injection valve 30 according to the present embodiment is provided with the spiral fuel path 38 which is formed to the outside of the side surface of the needle 32 away from the axis of the needle 32, so that the strong swirling component is given to the flow of the fuel. Thereby, the spray of the fuel is atomized without enlarging the needle 32, and stable combustion is realized.

Thus, there are the following advantages by restraining the weight increment of the needle 32. That is, when the needle is heavy, the response with respect to the operation of the needle is bad. However, when the needle is lightweight as described in the present embodiment, the response is good. Especially, when the fuel is intermittently injected, the transient response is improved largely. In addition, if the response is good, the swirling flow can be generated promptly even when the needle 32 starts lifting at the time of injection start. Therefore, the spray including the bubbles can be generated from the injection start, and the fuel can be atomized. Especially, the downstream side of the fuel path 38 is formed along the hemisphere surface, so that the swirling flow occurs since the needle has been opened, and the spray including the fine bubbles can be injected since the injection start.

Since the diameter of the needle 32 is not enlarged, a clearance between the needle 32 and the needle guide 34 can be small. When the clearance is small, the inflow of the fuel is restrained, and hence the pressure to be given to the fuel introduced to the spiral fuel path 38 can be reduced. Thereby, the pressure loss of the fuel can decrease, the driving loss of the fuel pump can be reduced, and the cost can be reduced.

Since the needle 32 is lightweight, the power consumption required for driving the needle 32 can be restrained. Moreover, since the enlargement of the fuel injection valve 30 itself is restrained, the fuel injection valve can be installed in a small engine.

In order to form the spiral fuel path 38 into the nozzle body 31, a coiled spiral member is supported by the adjustment room 37 and the injection hole 33, casting is performed by a lost-wax method, and hence the coiled spiral member is vanished. Thereby, the spiral fuel path 38 can be formed as a cavity portion.

### Second Embodiment

Next, a description will be given of a second embodiment of the present invention. The structure of a fuel injection valve 50 according to a second embodiment is substantially the same as that of the fuel injection valve 30 according to the first embodiment. Here, the fuel injection valve 50 is different from the fuel injection valve 30 according to the first embodiment in that the fuel injection valve 50 includes a swirling flow generation member 60 in the inside of a nozzle body 51. In the following description of the fuel injection valve 50, component elements identical to the fuel injection valve 30 of the first embodiment are described by using identical numerals.

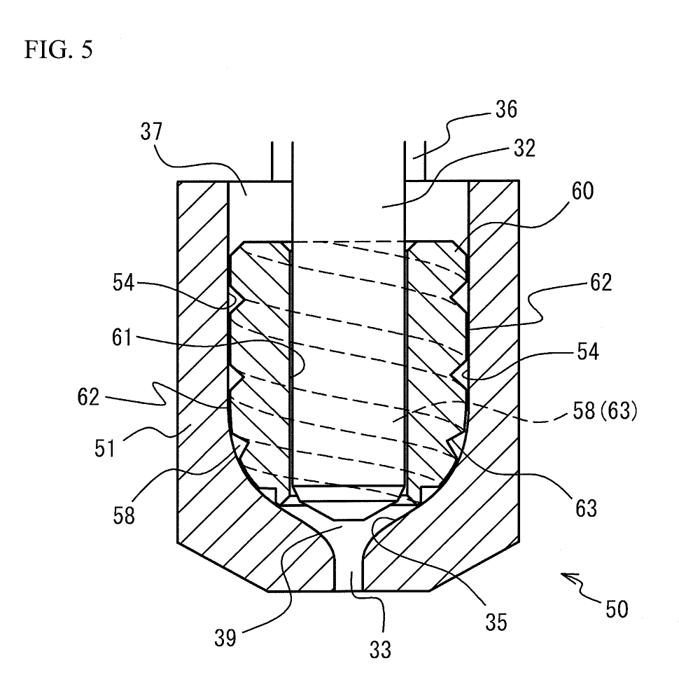

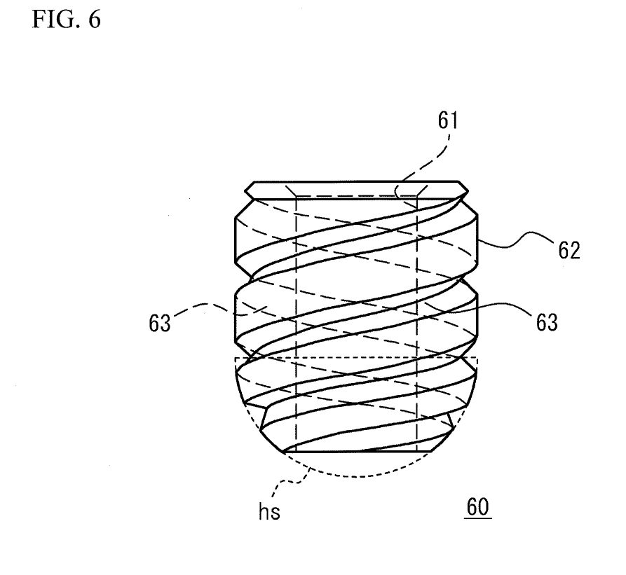

FIG. 5 is an explanatory cross-section diagram illustrating the schematic structure of the vicinity of the swirling flow generation member 60 in the fuel injection valve 50. Then, FIG. 6 is an explanatory diagram illustrating an appearance of the swirling flow generation member 60. As with the fuel injection valve 30 according to the first embodiment, the injection hole 33, the seat portion 35, and the acceleration portion 39 are formed at the front edge of the nozzle body 51 of the fuel injection valve 50. In addition, the fuel introduction path 36 is formed between the needle 32 and the nozzle body 51. The adjustment room 37 for storing the fuel is formed at the front edge side of the fuel introduction path 36. Instead of the needle guide 34 not being formed, the inside of the nozzle body 51 is formed so that the swirling flow generation member 60 formed cylindrically is housed. The swirling flow generation member 60 is attached between the fuel introduction path 36 and the seat portion 35 in the inside of the nozzle body 51. The needle 32 is slidably arranged in the nozzle body 51 and sits on the seat portion 35 in the nozzle body 51. The needle 32 slidably penetrates along an inner circumferential side surface 61 of the swirling flow generation member 60. That is, the inner circumferential side surface 61 of the swirling flow generation member 60 serves as the needle guide that guides the needle 32.

Moreover, a spiral groove 63 is provided on an outer circumferential side surface 62 of the swirling flow generation member 60. The swirling flow generation member 60 is embedded and press-fixed in the inside of the nozzle body 51. Thereby, the spiral fuel path 58 is formed with the spiral groove 63 of the swirling flow generation member 60 and an inner circumferential side surface 54 of the nozzle body 51. Thus, also when the swirling flow generation member 60 distinct from the nozzle body 51 is embedded, the fuel injection valve 50 can include the spiral fuel path 58 which is formed to the outside of the side surface of the needle 32 away from the axis of the needle 32.

Then, an outer circumferential surface of the swirling flow generation member 60 is processed on a normal line of a hemisphere which has a center on the axis of the needle 32. The spiral groove 63 is formed at a constant depth. Therefore, the cross-sectional area of the spiral fuel path 58 is constant at any position of the path, and the contracted flow of the fuel is restrained. Accordingly, the flow resistance in the fuel path 58 becomes small, and the lowering of the fuel pressure is restrained.

The downstream side of the spiral groove 63 of the swirling flow generation member 60 is formed along the hemisphere surface hs. Thereby, the downstream side of the fuel path 58 through which the fuel flows is formed along the hemisphere surface, so that a spiral radius of the fuel path 58 reduces gradually. Thus, since the spiral radius reduces gradually, the flow of the direction in which the fuel swirls is formed efficiently until the fuel passes through an exit in the side of the seat portion 35.

The fuel injection valve 50 is provided with the spiral fuel path 58 which is formed to the outside of the side surface of the needle 32, so that the strong swirling component is given to the flow of the fuel. Therefore, as with the fuel injection valve 30 according to the first embodiment, the spray of the fuel is atomized without enlarging the needle 32, and stable combustion is realized. Thereby, the weight increment of the needle 32 is restrained, there are advantages of improving the response of the needle 32, atomizing the fuel immediately after the injection start, reducing cost by reduction of the driving loss of the fuel pump, restraining the power consumption required for the driving of the needle 32, and installing the fuel injection valve to the small engine by restraint of the enlargement of the fuel injection valve itself, as with the above-mentioned the fuel injection valve 30.

Moreover, the fuel injection valve 50 is provided with the spiral fuel path 58 by combining the swirling flow generation member 60 which is a structural member distinct from the nozzle body 51. Thereby, it is easy to process the spiral groove 63, so that productivity can be improved. Since the spiral groove 63 is formed on the outer circumference of the swirling flow generation member 60, the surface roughness of the spiral groove 63 can be improved. Therefore, the flow resistance becomes small, and the lowering of the fuel pressure is restrained. Thus, the fuel injection valve is composed of the distinct structural member, and hence the number of parts increases, but the selection flexibility of material increases. Moreover, the productivity can be improved, and hence the cost can be reduced.

### Third Embodiment

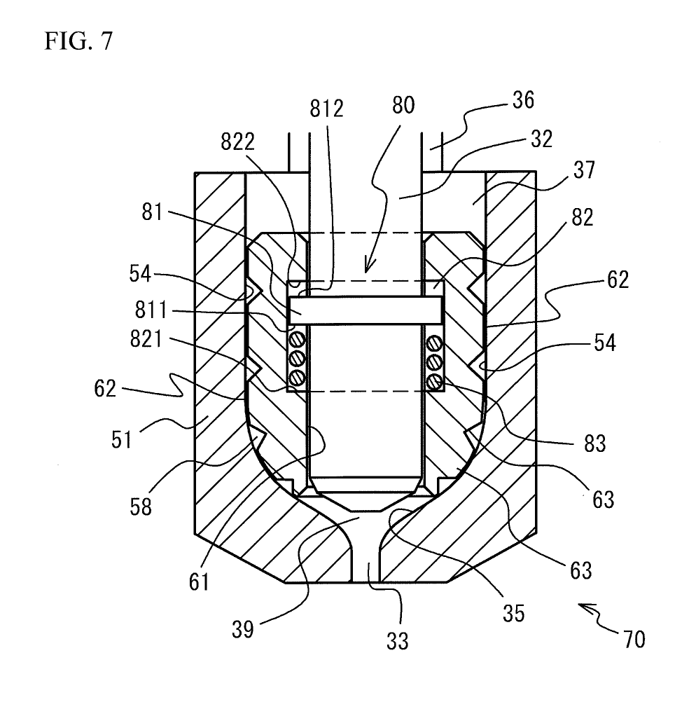

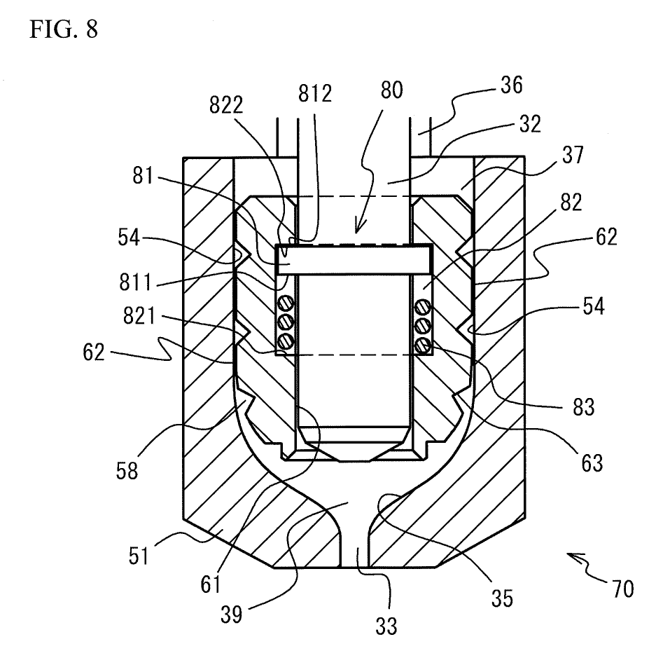

Next, a description will be given of a third embodiment of the present invention. FIGS. 7 and 8 are explanatory cross-section diagrams of the front edge portion of a fuel injection valve 70 according to a third embodiment. FIG. 7 illustrates a state where only the needle 32 is lifted. FIG. 8 illustrates a state where the swirling flow generation member 60 is lifted along with the needle 32. The structure of the fuel injection valve 70 according to the third embodiment is substantially the same as that of the fuel injection valve 50 according to the second embodiment. Here, the fuel injection valve 70 is different from the fuel injection valve 50 according to the second embodiment in including a moving mechanism 80. Further, the swirling flow generation member 60 according to the second embodiment is not lifted along with the needle 32, but the swirling flow generation member 60 according to the present embodiment may be lifted along with the needle 32. In the following description of the fuel injection valve 70, component elements identical to the fuel injection valve 50 are described by using identical numerals.

The moving mechanism 80 includes: a jaw portion 81 provided on the needle 32; a recess portion 82 that is formed on the inner circumferential side surface 61 of the swirling flow generation member 60 and in which the jaw portion 81 moves slidably; and a spring (an elastic member) 83 that presses the swirling flow generation member 60 to the front edge side of the needle 32. The spring 83 is provided between a front edge surface 821 of the recess portion 82 and a front edge surface 811 of the jaw portion 81. The outer circumferential side surface 62 of the swirling flow generation member 60 can slide against the inner circumferential side surface 54 of the nozzle body 51. Other components are the same as corresponding components of the fuel injection valve 50 according to the second embodiment, and a description thereof is omitted.

Next, a description will be given of a relationship between a lift amount of the needle 32 and the operation of the moving mechanism 80. The fuel injection valve 70 adjusts an injection quantity of the fuel according to the lift amount of the needle 32. Therefore, when there is little injection quantity, the lift amount of the needle 32 becomes small. When there is much injection quantity, the lift amount of the needle 32 becomes large. When there is little injection quantity of the fuel, i.e., when the lift amount of the needle 32 is small in the fuel injection valve 70, a rear edge surface 812 of the jaw portion 81 does not reach a rear edge surface 822 of the recess portion 82 even if the needle 32 lifts, as illustrated in FIG. 7. Therefore, only the needle 32 lifts. In this case, the fuel passes through all of the fuel path 58, is supplied to the acceleration portion 39, and is injected. Therefore, when the lift amount of the needle 32 is small, the fuel passes through the spiral path for a long time, and hence the swirling flow is more strengthened.

On the contrary, when there is much injection quantity of the fuel, i.e., when the lift amount of the needle 32 is large in the fuel injection valve 70, the needle 32 lifts and the rear edge surface 812 of the jaw portion 81 contacts the rear edge surface 822 of the recess portion 82, as illustrated in FIG. 8. Moreover, when the needle 32 lifts, the swirling flow generation member 60 lifts along with the needle 32. In this case, the downstream side of the fuel path 58 which is formed with the swirling flow generation member 60 and the nozzle body 51 is opened, and hence a cross-section area of the flow path is enlarged. Thereby, the pressure loss of the fuel by flow path resistance is reduced.

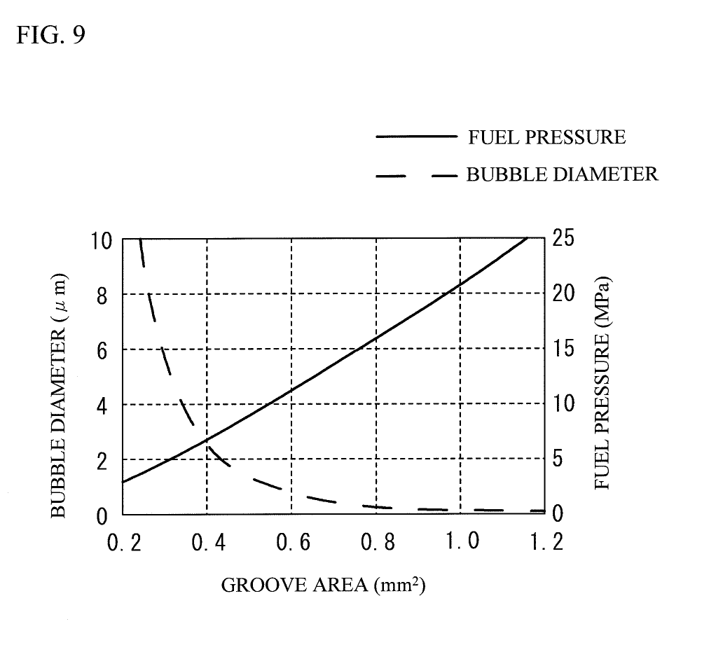

Here, a description will be given of the influence by a groove area formed spirally. FIG. 9 is an explanatory diagram illustrating a relationship between a bubble diameter and a fuel pressure. In FIG. 9, a broken line indicates a relationship between the bubble diameter and the groove area, and a solid line indicates a relationship between the fuel pressure and the groove area. As the cross-sectional area (i.e., the groove area) of the spiral fuel path 58 becomes small, the flow velocity of the swirling flow becomes fast and the bubble diameter to be generated becomes small, as illustrated in FIG. 9. However, since the pressure loss by the flow path is determined by the cross-sectional area and the length of the path, the pressure loss of the fuel becomes large as the cross-sectional area becomes small. Therefore, as the path area is reduced, it is required that the fuel pressure is heightened.

When there is little fuel flow and the lift amount is small, the fuel injection valve 70 according to the present embodiment accelerates the swirling flow by the whole spiral fuel path, and advances the miniaturization of the bubble diameter. On the contrary, when there is much fuel flow and the lift amount is large, the fuel injection valve 70 makes the pressure loss small and restrains the rise of the fuel pressure by generating the swirling flow by a part of the fuel path. Thereby, even when there is much fuel flow, the fuel flow is secured with a low fuel pressure, and the swirling velocity generating the fine bubbles is also secured simultaneously.

The above-mentioned embodiments are merely examples carrying out the present invention. Therefore, the present invention is not limited to those, and various modification and change could be made hereto without departing from the spirit and scope of the claimed present invention. In addition, it is obvious that other various embodiments could be made in the scope of the present invention.

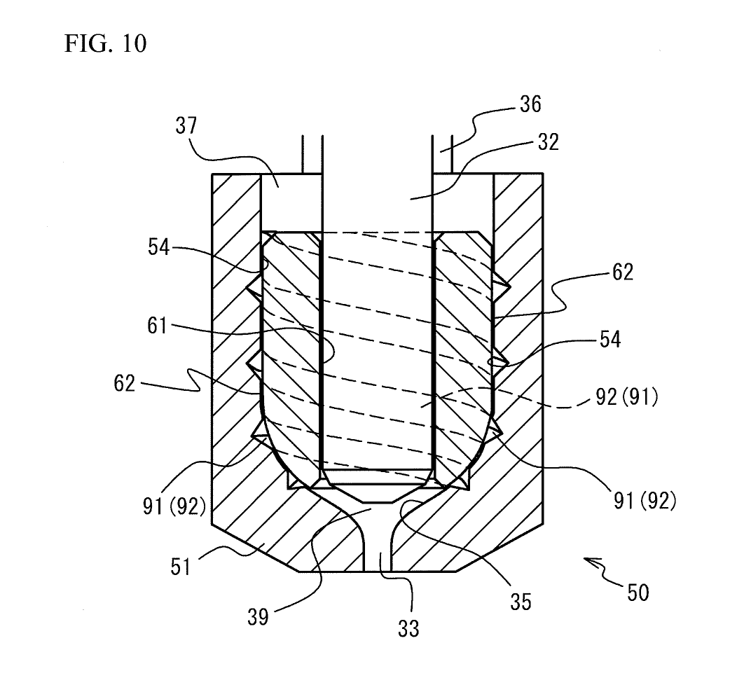

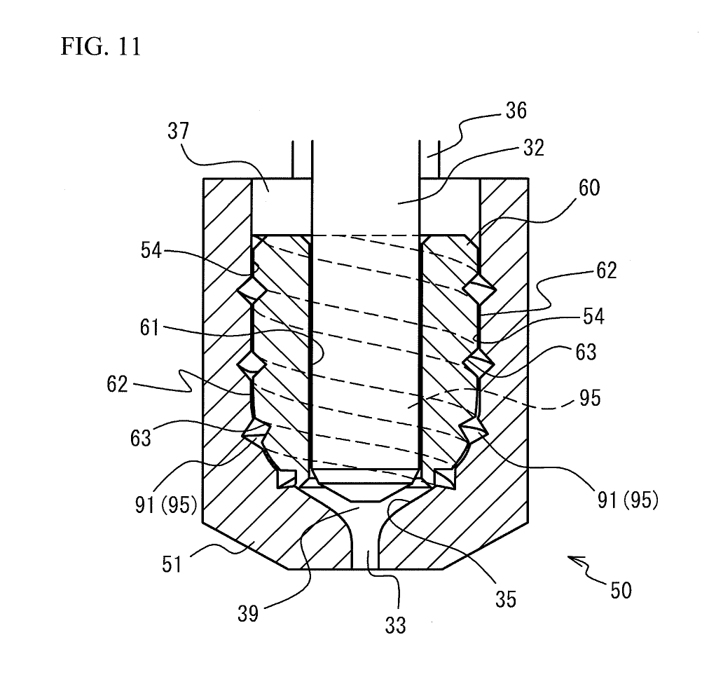

For example, in the above-mentioned second embodiment, a spiral groove 91 is provided on the inner circumferential side surface 54 of the nozzle body 51 as substitute for the swirling flow generation member, so that a spiral fuel path 92 may be formed, as illustrated in FIG. 10. Also, the spiral groove 63 is provided on the outer circumferential side surface 62 of the swirling flow generation member and the spiral groove 91 is provided on the inner circumferential side surface 54 of the nozzle body 51, so that a spiral fuel path 95 may be formed, as illustrated in FIG. 11.

### DESCRIPTION OF LETTERS OR NUMERALS

1 . . . engine system
30, 50, 70 . . . fuel injection valve
31, 51 . . . nozzle body
32 . . . needle
33 . . . injection hole
34 . . . needle guide
35 . . . seat portion
36 . . . fuel introduction path
37 . . . adjustment room
38, 58, 92, 95 . . . fuel path
39 . . . acceleration portion
40 . . . driving mechanism
60 . . . swirling flow generation member
63, 91 . . . spiral groove
80 . . . moving mechanism
81 . . . jaw portion
82 . . . recess portion
83 . . . spring (elastic member)
fs . . . swirling flow
f₁ . . . fuel flow
f₂ . . . bubble mixture flow
hs . . . hemisphere surface
s . . . spray

1. A fuel injection valve comprising:
a nozzle body having a frond edge portion at which an injection hole is provided;
a needle that is slidably arranged in the nozzle body and sits on a seat portion in the nozzle body, the needle and the nozzle body forming a fuel introduction path therebetween;
a spiral fuel path that is formed at an upstream side of the seat portion, and gives a flow which swirls around the needle to a fuel which is introduced from the fuel introduction path and supplied to the injection hole; and
an acceleration portion that is formed between the seat portion and the injection hole, accelerates the swirling fuel which has passed through the fuel path, and generates a negative pressure at the center of swirling flow of the fuel to generate an air core;
wherein the fuel path is formed to the outside of an outer peripheral surface of the needle.

2. The fuel injection valve according to claim 1, further comprising:
a swirling flow generation member arranged between the fuel introduction path and the seat portion in the inside of the nozzle body;
wherein the needle slidably penetrates the swirling flow generation member, and
the fuel path is formed with at least one of a spiral groove provided on an inner circumferential side surface of the nozzle body, and a spiral groove provided on an outer circumferential side surface of the swirling flow generation member.

3. The fuel injection valve according to claim 1, wherein the fuel path is formed so as to penetrate the inside of the nozzle body.

4. The fuel injection valve according to claim 1, wherein a downstream side of the fuel path is formed along a hemisphere surface.

5. The fuel injection valve according to claim 1, wherein a cross-sectional area of the fuel path is constant.

6. The fuel injection valve according to claim 2, further comprising:
a moving mechanism that moves only the needle when a lift amount of the needle is small, and moves the needle and the swirling flow generation member when the lift amount of the needle is large.

7. The fuel injection valve according to claim 6, wherein the moving mechanism includes:
a jaw portion provided on the needle;
a recess portion that is formed on an inner circumferential side surface of the swirling flow generation member, and is configured so that the jaw portion moves slidably; and
an elastic member that is provided between a front edge surface of the recess portion and a front edge surface of the jaw portion, and presses the swirling flow generation member to a front edge side of the needle;
wherein when the needle lifts and a rear edge surface of the jaw portion contacts a rear edge surface of the recess portion, the swirling flow generation member moves along with the needle.
